(19) United States
(12) Patent Application Publication
(10) Pub. No.: US 2011/0239863 A1
(43) Pub. Date: Oct. 6, 2011

(54) Stripping column and process for extracting a component from a liquid medium

(75) Inventors: Thierry Cartage, Brussels (BE); Andrea Salto, Bahia Blanca (AR); Pedro Ribeiro, Ribeirao Pires (BR)

(73) Assignee: SOLVAY SA, Brussels (BE)

(21) Appl. No.: 13/132,615

(22) PCT Filed: Dec. 15, 2009
(86) PCT No.: PCT/EP2009/067143

§ 371 Date: Jun. 3, 2011

(30) Foreign Application Priority Data
Dec. 22, 2008 (FR) 0858916

(51) Int. Cl. B01D 19/00

(52) U.S. Cl. 95/159; 96/202

(57) ABSTRACT

Stripping column and process for extracting a component from a liquid medium using a gas, the stripping column comprising a vertical column (10) comprising an essentially cylindrical wall (54), the vertical column (10) being divided by horizontal perforated plates (20) into a series of superposed chambers (11, 12, . . . , 16, 17), each chamber (11, 12, . . . , 16, 17) comprising several vertical partitions (34, 34^{I}, 34^{II}, 34^{III}, 34^{IV}, 34^{V}) positioned so as to form chicanes, an upper chamber (17) comprising at least one liquid medium inlet port (28). According to one important aspect of the invention, the upper chamber (17) comprises a liquid medium receiving zone (90), the receiving zone (90) being configured so as to be able to carry out a degassing of the liquid medium in the receiving zone (90).

The present invention relates to a stripping column for extracting a component from a liquid medium using a gas, in particular for extracting a monomer from an aqueous polymer slurry.

Suspension polymerization is a technique that is commonly used to manufacture polyvinyl chloride (PVC). In this known technique, a vinyl monomer (vinyl chloride) is polymerized in the presence of an aqueous medium, and the polymerization is stopped before all of the vinyl chloride has been polymerized. In general, the polymerization is stopped when 80 to 95% of the amount of monomer has been converted into polymer. The result of this is that the aqueous slurry of polyvinyl chloride collected after the polymerization contains an appreciable amount of residual vinyl monomer which should be removed.

Document EP 0 756 883 describes an installation which is specially designed for treating such polyvinyl chloride slurries, in order to remove therefrom the residual vinyl monomer they contain. This known installation comprises a vertical column, divided into a series of chambers on which perforated horizontal plates are superposed. After preheating the aqueous slurry to be purified to a temperature of about from 50° C. to 100° C., it is introduced into the column and flushed with an ascending stream of gas in order to extract the vinyl monomer it contains.

In practice, disturbances are observed in the flow of the slurry in the column, mainly in the case of a high flow rate. These disturbances especially include spraying of the slurry onto the walls of the column, at the inlet of this column. They have a detrimental effect on the yield for the purification of the slurry and run the risk of damaging the plates and the other constituent components of the column. One means for overcoming these disturbances would be to work with low flow rates of slurry and low temperatures at the column inlet, but this would result in a loss of productivity.

Hence, it has been attempted to overcome this drawback by providing an expansion chamber in order to treat the slurry entering the vertical column by subjecting it to an expansion. This drop in pressure can be achieved by any suitable technical means, one especially easy means consisting in introducing the slurry into a chamber of large volume.

Thus it has been suggested, for example in U.S. Pat. No. 6,375,793, to provide an upper chamber with a diameter larger than that of the subjacent chambers. The upper chamber then has a larger volume and the aqueous slurry can expand. However, the enlargement of the upper chamber leads to a more complicated construction of the vertical column.

Another possibility for the degassing is to provide an expansion unit upstream of the inlet into the vertical column. Such an expansion unit may comprise, as proposed in EP 1 296 747, a cylindrical enclosure, the lower part of which is connected to the vertical column and the upper part of which allows a discharge of gas. Thus, the cylindrical enclosure allows the aqueous slurry to expand before arriving in the vertical column. Such an external expansion unit also leads, however, to a larger space requirement and to higher costs.

The object of the present invention is consequently to propose an alternative stripping column which allows a sufficient expansion of the liquid medium, without however exhibiting the disadvantages of the systems proposed above.

In accordance with the invention, this objective is achieved by a stripping column for extracting a component from a liquid medium using a gas, the stripping column comprising a vertical column with an essentially cylindrical wall, the vertical column being divided by horizontal perforated plates into a series of superposed chambers, each chamber comprising several vertical partitions positioned so as to form chicanes, an upper chamber comprising at least one liquid medium inlet port. According to the invention, the upper chamber comprises a liquid medium receiving zone, the receiving zone being configured so as to be able to carry out a degassing of the liquid medium in the receiving zone.

The vertical column according to the invention hence allows sufficient expansion of the liquid medium in the receiving zone of the upper chamber. Since this expansion can be carried out in the receiving zone of the upper chamber, it is not necessary to provide an external expansion unit. With the receiving zone being specially adapted for degassing, the construction of the upper chamber does not need to be considerably different from the subjacent chambers. The construction of the vertical column is thus made easier and less expensive.

The term “component” is understood to mean any component present in the liquid medium that may be extracted from this liquid medium by means of a gas. Such a component present in the liquid medium may be a gaseous compound or a liquid compound that is converted to a gaseous compound during the extraction by the gas. As examples of a component, mention may be made of ammonia, carbon dioxide, a monomer such as, for example, vinyl chloride, and also volatile organic compounds. The component is preferably carbon dioxide or a monomer such as vinyl chloride, particularly preferably a monomer and very particularly preferably vinyl chloride.

The expression “liquid medium” is understood to mean any liquid medium, whether it is aqueous or organic, that may or may not comprise solid particles. As examples of a liquid medium, mention may be made of solutions that do not comprise solid particles and suspensions (also known as slurries) that comprise solid particles. The liquid medium is preferably an aqueous liquid medium that is or is not charged with solid particles; particularly preferably an aqueous liquid medium charged with solid particles such as suspensions or slurries, very particularly preferably an aqueous polymer slurry and very particularly preferably indeed, an aqueous slurry of polyvinyl chloride.

Thus, the vertical column may be used, for example, for the debicarbonation of a carbonate/bicarbonate solution, for the purification of waters such as the wastewaters that may be reused as process waters and washing waters, or for the extraction of a monomer from an aqueous polymer slurry. Preferably, the column is used for the extraction of a monomer from an aqueous polymer slurry and particularly preferably for the extraction of vinyl chloride from a polyvinyl chloride slurry.

As examples of a gas, mention may be made of steam, air and inert gases. Steam is preferred.

The upper chamber preferably has a diameter that corresponds to the diameter of the subjacent chambers. The construction of the vertical column is simplified by the fact that the vertical column may have a cylindrical external appearance over its entire height. This simplified construction leads to a lower production cost.

According to one embodiment, the receiving zone is formed by removing at least one vertical partition. The removal of a vertical partition enables an enlargement of the receiving zone that is simple to obtain. The enlargement of the receiving zone has the effect of increasing the volume of the zone dedicated to degassing, thus increasing the degassing effect in the vertical column.

According to one preferred embodiment, the receiving zone is formed by modifying at least one vertical partition. The modification of a vertical partition also enables an enlargement of the receiving zone. The enlargement of the receiving zone has the effect of increasing the volume of the zone dedicated to degassing, thus increasing the degassing effect in the vertical column. The modification of a vertical partition enables the vertical partition to be retained, at least in part. This may be of particular advantage when the vertical partition is part of the load-bearing structure of the vertical column.

The vertical partition in the receiving zone advantageously has a reduced height relative to the other vertical partitions, thus allowing the distribution of the liquid medium on both sides of the partition.

The vertical partition in the receiving zone preferably comprises at least one opening in its lower edge, thus allowing the distribution of the liquid medium on both sides of the partition. Such an opening in the lower edge of the vertical partition also makes it possible to prevent an accumulation of solids on the perforated plate.

The perforated plate preferably comprises, in the receiving zone, a reduced number of perforations, thus limiting evaporation and reducing the foaming effect.

According to one preferred embodiment, the stripping column comprises a turbulence means that makes it possible to create turbulence of the liquid medium in the receiving zone. Turbulence of the liquid medium improves the degassing conditions of the liquid medium. The turbulence means may be formed by a feed pipe comprising a bend that directs the flow of liquid medium into a predefined region of the receiving zone. Alternatively or additionally, the turbulence means may be formed by a deflector downstream of the liquid medium inlet into the upper chamber. Such a deflector breaks up the flow of the jet of liquid medium entering into the upper chamber and may comprise a part that forms a funnel directing the liquid medium to a predefined region of the receiving zone.

According to one aspect of the invention, the vertical partitions are advantageously attached to the wall of the vertical column and are advantageously designed so as to hold the perforated plates. In such a stripping column, it is no longer the perforated plate that bears the partition, but the partition that advantageously bears the perforated plate. Indeed, the load-bearing structure of the stripping column is now advantageously formed by the vertical partitions and the wall of the vertical column. These vertical partitions are advantageously directly attached to the wall of the vertical column in order to form the chicanes for the liquid medium to be treated. The vertical partitions are advantageously formed so as to hold, preferably at their lower edge, a perforated plate.

The perforated plate is advantageously formed by a plurality of plate sections preferably having a width that corresponds to the distance between two vertical partitions or between a vertical partition and the wall of the vertical column. The perforated plate is therefore advantageously divided into a plurality of smaller components. Such plate sections are light, flexible and easy to manipulate into place. The use of plate sections also facilitates the reduction of the number of perforations in the receiving zone.

The plate sections advantageously have a thickness between 2 and 8 mm, preferably around 4 mm. The thickness is advantageously less than or equal to 8 mm, preferably less than or equal to 6 mm, but advantageously greater than or equal to 2 mm. The thickness of the perforated plates is therefore reduced relative to conventional plates, which generally have a minimum thickness of 10 mm.

The vertical partition preferably has a cross section in the shape of an upside-down “T” and comprises, on its lower edge, a flange that extends on both sides of the vertical partition and that acts as support for the plate sections. The vertical partitions may thus readily receive the plate sections between them and bear these sections. A plate section advantageously rests on the flange of the vertical partition and is preferably attached thereto, for example by welding or bolting.

The perforations in the plate sections are advantageously essentially cylindrical. Perforations of cylindrical shape can be produced rapidly, which allows a rapid and less expensive manufacture of the plate sections. It should be noted that the perforations of cylindrical shape constitute a significant advantage when the number of perforations per perforated plate is considered, which may exceed 1500 perforations per m², or even 2000 perforations per m². According to the prior art, the perforations generally have a more complicated shape with two cylindrical parts of different diameter connected by a frustum of a cone. The diameter of the cylindrical part on the upper side of the plate is of the order of 1.2 mm and the diameter of the cylindrical part on the lower side of the plate is of the order of 6 mm; the angle of the cone being less than 120° and the thickness of the perforated plate of the order of 12 mm. The manufacture of such perforations requires either one special piercing tool or two separate piercing tools. Owing to the fact that the plate sections have a smaller thickness, these perforations of complex shape can be replaced by perforations of simple cylindrical shape. It should be noted that, although the perforations are preferably of cylindrical shape, it is not excluded to provide perforations having other shapes, such as for example shapes that are at least partially conical with a downwards or upwards opening.

The wall of the vertical column is advantageously formed as a single part. An assembling of several construction components in order to form the vertical column is no longer necessary. The clamps and seals between the various construction components can be eliminated. Indeed, owing to the load-bearing structure formed by the vertical partitions and the plate sections, which are more easily replacable, of the inside of the column, the dismantling of the column is not necessary in order to access the various horizontal plates, in particular due to the presence of manholes.

The vertical partitions are preferably welded to the wall of the vertical column. It is not however excluded to attach the vertical partitions to the wall of the vertical column by another means such as, for example, bolting.

Each vertical partition advantageously comprises a first end and a second end, the first end being attached to the wall of the vertical column. According to one embodiment, the second end is arranged at a certain distance from the wall of the vertical column so as to form an opening for the passage of the liquid medium. According to another preferred embodiment, the second end comprises a strut connected, on the one hand, to the vertical partition and, on the other hand, to the wall of the vertical column, the strut being designed so as to form an opening through the vertical partition.

A rinsing system, preferably a high-pressure rinsing system, is advantageously arranged in the chamber to clean the lower face of the plate sections positioned overhead. Such a rinsing system may comprise a distribution ring that is coaxial with the perforated plate, the distribution ring comprising a plurality of high-pressure nozzles positioned so that the jets emanating from the nozzles cover the entire lower face of the perforated plate. A supplementary nozzle, the jet of which is pointed at a porthole of the chamber, may be provided in order to carry out the cleaning of the porthole. Such a rinsing system makes it possible to prevent the attachment of residues, especially of PVC, onto the lower face of the perforated plate. The present rinsing system has better performance than the known rinsing systems, which are composed of concentric circular pipes with a large number of large-diameter holes.

A perforated plate advantageously comprises a discharge zone with a discharge opening allowing the flow of the liquid medium from one chamber to a subjacent chamber. According to one aspect of the invention, a barrier is positioned upstream of the discharge opening, the barrier regulating the height of the liquid medium in the chamber.

Preferably, the barrier is removably attached to a vertical partition and/or to the wall of the vertical column. The barrier may, for example, be bolted to the vertical partition and/or to the wall. Thus, the barrier can be easily dismantled and may be replaced by a barrier of a different height, therefore allowing an easy adjustment of the height of the liquid medium in a chamber. The barrier may comprise an opening in its lower part that aims to promote the drainage of possible suspended solids. Preferably, the barrier comprises such an opening in its lower part.

The invention also relates to a stripping process for extracting a component from a liquid medium using a gas, in particular for extracting a monomer from an aqueous polymer slurry, the process using a stripping column according to the invention.

Other particularities and features of the invention will appear from the detailed description of some advantageous embodiments given below, by way of illustration, with reference to the appended drawings.

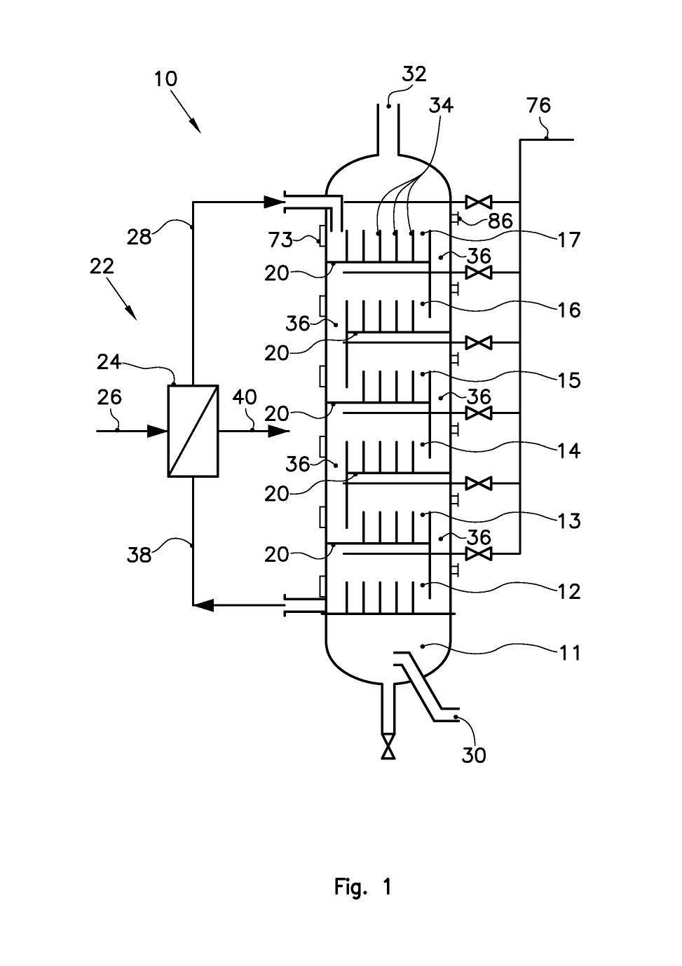

FIG. 1: is an elevation diagram of a vertical column;

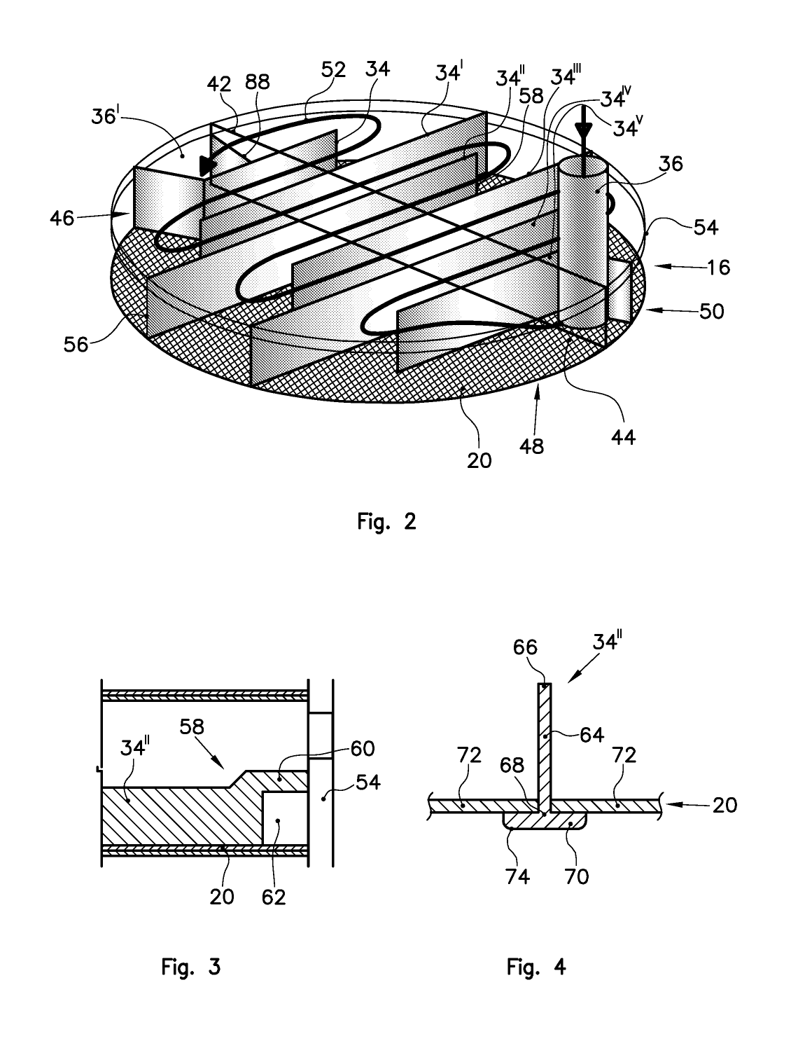

FIG. 2: is a perspective view of a chamber of the vertical column;

FIG. 3: is a front view of a second end of a vertical partition according to the invention;

FIG. 4: is a cross-sectional view through a vertical partition according to the invention;

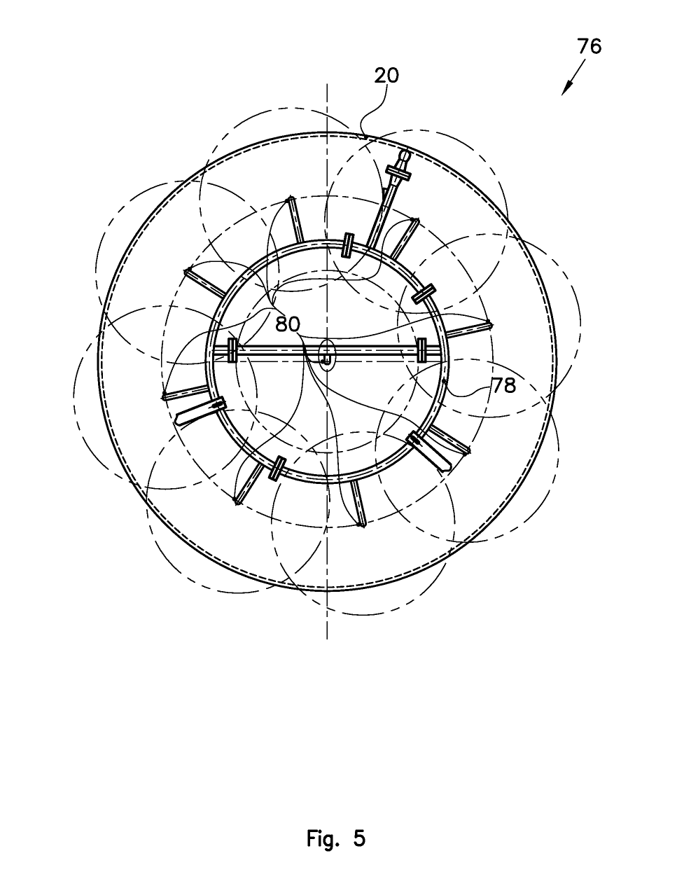

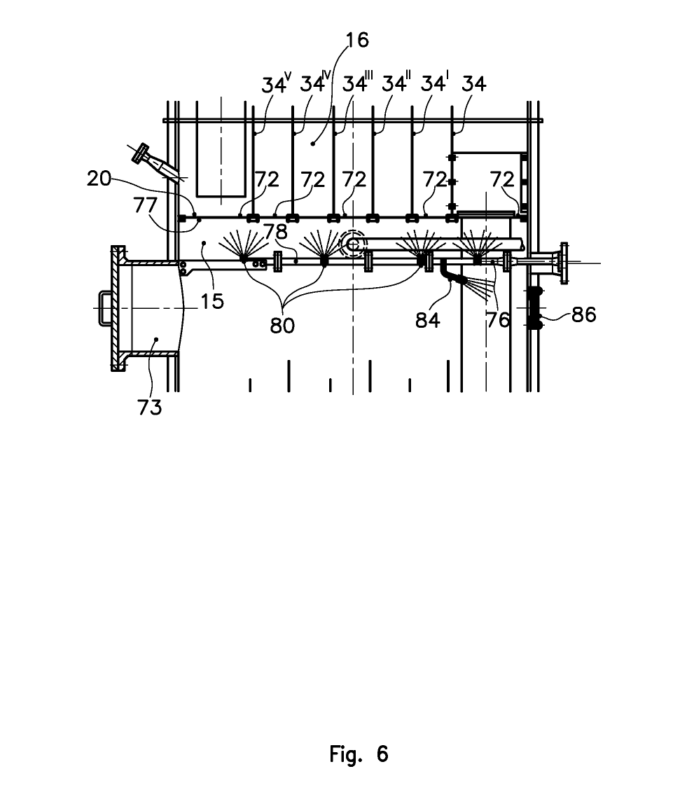

FIG. 5: is a schematic view of a rinsing system according to the invention;

FIG. 6: is a front view of the rinsing system from FIG. 5;

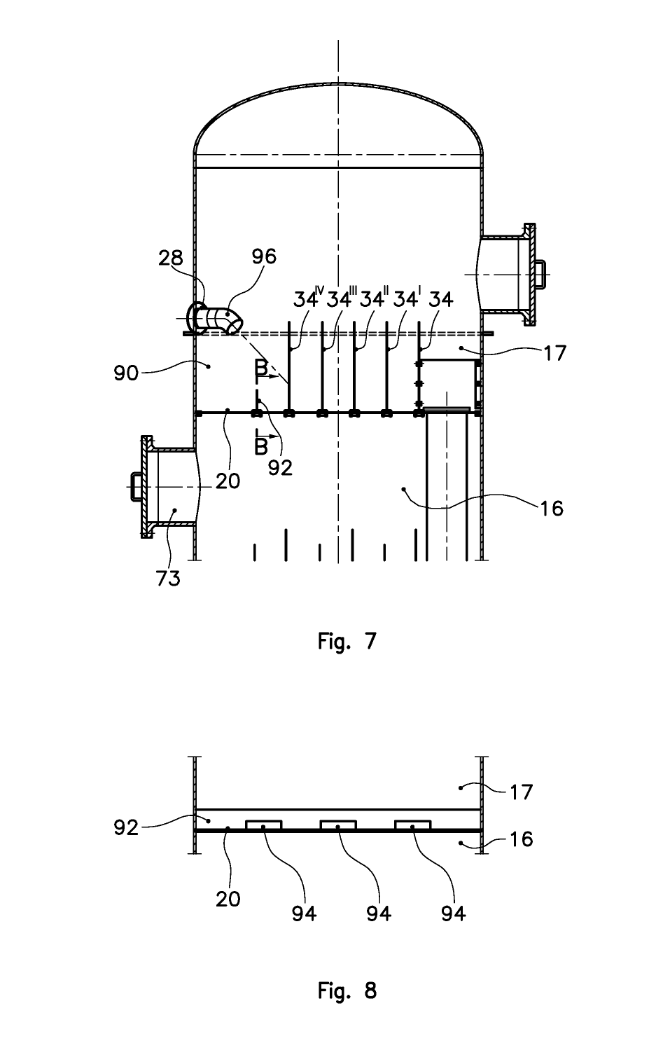

FIG. 7: is a cross-sectional view through the upper part of a vertical column according to the invention;

FIG. 8: is a front view of a partition of the vertical column from FIG. 7; and

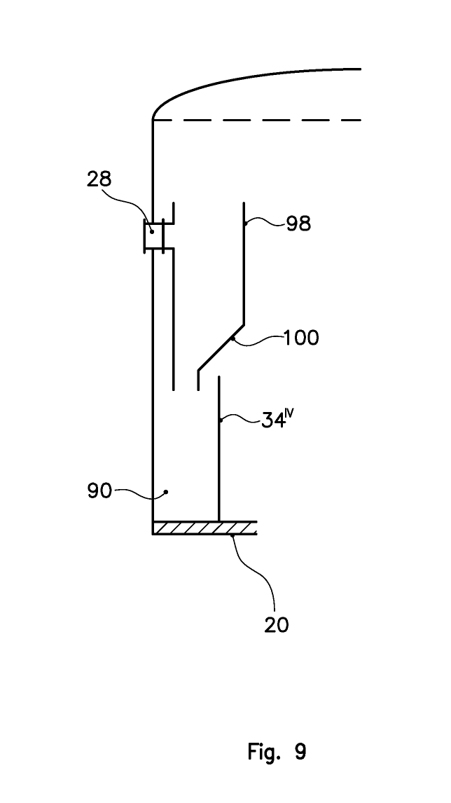

FIG. 9: is a partial cross section through the upper part of a vertical column according to the invention.

In these figures, the same reference numbers denote identical components.

The installation represented in FIG. 1 comprises a vertical column 10, divided into a succession of superposed chambers 11, 12, . . . , 16, 17, by horizontal perforated plates 20. The vertical column 10 illustrated is a column for the extraction of residual vinyl chloride from a polyvinyl chloride slurry. The upper chamber 17 of the vertical column 10 is in communication with a polyvinyl chloride slurry intake device, denoted in its entirety by the reference number 22. This intake device comprises a heater 24, a pipe 26 for introducing a slurry into the heater 24, and a feed pipe (inlet port) 28 between the heater 24 and the upper chamber 17 of the vertical column 10. A gas intake pipe 30 opens into the lower chamber 11 of the vertical column 10 and an output pipe 38 joins the chamber 12 to the heater 24. A vent 32 is provided at the top of the vertical column 10. Each chamber of the column may be equipped with manholes 73 and/or portholes 86. Details concerning the vertical column 10 and the operation thereof are available in document EP 0 756 883.

The installation is especially adapted to the treatment of polyvinyl chloride slurries obtained by the suspension polymerization technique. These slurries are contaminated with vinyl chloride which is residual from the polymerization. In this particular application of the installation, the polyvinyl chloride slurry originating from the polymerization is introduced into the heater 24 via the intake pipe 26. In the heater 24, the slurry is heated to a temperature of around 100° C. The hot slurry is transferred from the heater 24 into the upper chamber 17 of the vertical column 10 via the feed pipe (inlet port) 28.

In the upper chamber 17 of the vertical column 10, the slurry drops onto the plate 20, where it circulates in chicanes formed by a network of vertical partitions 34, before reaching an overflow 36 through which it drops in order to reach the plate 20 of the subjacent chamber 16 of the vertical column 10. In this way the slurry gradually descends through the vertical column 10, to the chamber 12. While it flows from top to bottom through the vertical column 10, the slurry is flushed with an ascending stream of gas which is introduced into the bottom of the column via the pipe 30. The result of flushing the slurry with the gas stream is that the vinyl chloride present in the slurry is extracted and entrained to the top of the vertical column 10. The gas charged with vinyl chloride is discharged from the headspace of the vertical column 10 via the vent 32. The slurry which reaches the chamber 12 is substantially free of vinyl chloride and it is hot. It is discharged from the vertical column 10 via an outlet pipe 38 and is introduced into the heater 24 where its sensible heat is used to heat the slurry which enters therein via the pipe 26. The slurry cooled in the heater 24 exits this heater via an extraction pipe 40. Details concerning the circulation and treatment of the slurry in the vertical column 10 are available in document EP 0 756 883.

A chamber, for example the chamber 16, is shown in greater detail in FIG. 2, illustrating in particular the arrangement of the vertical partitions 34.

FIG. 2 shows a vertical plane 42, crossing the centre of the chamber 16 and going from an inlet zone 44, which receives, through an overflow 36, the aqueous slurry originating from a superjacent chamber 17, to an outlet zone 46, which discharges, through an overflow 36′, the aqueous slurry to a subjacent chamber 15. This vertical plane 42 divides the chamber 16 into a first half 48 and a second half 50. A plurality of vertical partitions 34, 34^{I}, 34^{II}, 34^{III}, 34^{IV}, 34^{V} are arranged essentially perpendicular to the vertical plane 42. The vertical partitions 34, 34^{I}, 34^{II}, 34^{III}, 34^{IV}, 34^{V} form chicanes that drive the aqueous slurry from the inlet zone 44 to the outlet zone 46; the flow of the aqueous slurry, generally represented by the arrow 52, being generally perpendicular to the vertical plane 42, except in the marginal zones of the chamber 16.

According to one aspect of the invention, the vertical partitions 34 are attached to the wall 54 of the vertical column 10. The vertical partitions 34, 34^{I}, 34^{II}, 34^{III}, 34^{VI}, 34^{V} have, each time, a first end connected to the wall 54 of the vertical column 10, alternately in the first or second half 48, 50 of the chamber 16. Thus, for example, the vertical partition 34″ comprises a first end 56 connected to the wall 54 in the first half 48 of the chamber 16 and a second end 58 in the second half 50 of the chamber 16. The various vertical partitions 34, 34^{I}, 34^{II}, 34^{III}, 34^{IV}, 34^{V} are essentially parallel to one another and perpendicular to the vertical plane 42.

The second end 58 may be, as illustrated in FIG. 2, arranged at a certain distance from the wall 54 thus allowing the passage of the aqueous slurry. Preferably, on the other hand, the second end 58 is attached to the wall 54 and comprises an opening that allows the passage of the aqueous slurry. This preferred embodiment is illustrated in FIG. 3, which shows, on a large scale, the second end 58 of the vertical partition 34^{II}. A strut 60 is provided between the vertical partition 34^{II} and the wall 54 thus allowing the second end 58 to be attached to the wall 54, while creating an opening 62 for the passage of the aqueous slurry through the vertical partition 34^{II}.

FIG. 4 shows a cross section through a vertical partition 34^{II} in the shape of an upside-down “T”, comprising a vertical portion 64 with an upper edge 66 and a lower edge 68. The lower edge 68 comprises a flange 70 that extends on both sides of the vertical portion 64 and that acts as support for the horizontal perforated plate 20. Indeed, the horizontal perforated plate 20 is formed by a plurality of plate sections 72, in strip form. The plate sections 72 have a width that corresponds to the distance between two neighbouring vertical partitions 34, 34^{I}, 34^{II}, 34^{III}, 34^{IV}, 34^{V} respectively between a vertical partition 34, 34^{V} and the wall 54. These plates sections 72 rest on the flange 70 of the vertical partitions and are attached thereto, for example by welding or bolting. The lower face 74 of the flange 70 is rounded at the corners in order to limit the points of attachment on the lower face of the perforated plate 20. As an alternative to the above solution, it is not excluded to provide a vertical partition having a cross section in the shape of an upside-down “T”, comprising a vertical portion with a flange at the lower edge; the flange being configured in order to receive the plate sections against its lower face, the plate sections being attached to the flange by bolting or welding. However, this solution creates, at the junctions between two plate sections, a hollow in the lower face of the perforated plate. Another alternative is to provide a flange with a shoulder and plate sections with corresponding shoulders, the assembling of the plate sections to the flanges taking place at the shoulders.

Since the load-bearing structure is formed by the vertical partitions 34, 34^{I}, 34^{II}, 34^{III}, 34^{VI}, 34^{V} attached to the wall 54 of the vertical column 10, the plate sections 72 may be of lower strength relative to the known installations in which the load-bearing structure is formed by the horizontal perforated plate. Therefore, the thickness of a plate section 72 may be from 2 to 8 mm. Such plate sections 72 have a certain flexibility and may be easily manipulated into place, for example through a manhole 73, in order, for example, to replace a damaged plate section. This replacement may be carried out from inside the vertical column 10, which therefore does not require the vertical column to be dismantled as is the case for the columns according to the prior art. It also ensues therefrom that the vertical column 10 can be constructed with one wall covering the entire height of the vertical column, that is to say without resorting to an assembling of several construction components. The clamps and seals between the various construction components no longer have an essential purpose and the leakage problems at these locations are therefore prevented.

According to another aspect of the invention, a rinsing system 76 is provided underneath the horizontal perforated plate 20 in order to clean the lower face 77 of this perforated plate 20. Such a rinsing system 76 is schematically represented in FIGS. 5 and 6. The rinsing system 76 according to the invention comprises a distribution ring 78, which is coaxial with the perforated plate 20, the distribution ring 78 comprising a plurality of nozzles 80, preferably high-pressure nozzles, positioned so that the jets emanating from the nozzles 80 cover the entire lower face 77 of the perforated plate 20. If the vertical column is equipped with portholes 86, a supplementary nozzle 84, the jet of which is pointed at a porthole 86 of the chamber 15, may be provided in order to carry out the cleaning of the porthole 86. Such a rinsing system 76 has better performance than the known system, which is composed of concentric circular pipes with a large number of holes, but which does not uniformly spray the entire lower face 77.

A barrier 88 (FIG. 2) is generally provided upstream of the overflow allowing the aqueous slurry to pass from one chamber to a subjacent chamber. The height of the barrier 88 defines the height of the aqueous slurry on the perforated plate. According to one aspect of the invention, the barrier 88 is bolted to the vertical partition 34 and/or to the wall 54, thus allowing it to be easily dismantled and replaced by a barrier of a different height. The height of the aqueous slurry on the perforated plate may thus be easily adjusted.

According to one important aspect of the invention, the vertical column 10 comprises a degassing zone in order to enable gas-liquid separation. Thus, as illustrated in FIG. 7, the present invention proposes a receiving zone 90 in an upper chamber 17 of the vertical column, the chamber 17 having the same diameter as the subjacent chambers 11, 12, . . . , 16. The receiving zone 90 is adapted in order to enable the degassing of the aqueous slurry. The receiving zone 90 may be formed by an enlargement of the part of the perforated plate that receives the aqueous slurry from the feed pipe (inlet port) 28. This enlargement of the receiving zone may be obtained by removing or modifying the first vertical partition 92 of the upper chamber 17 and optionally of one or more subjacent chambers. When the vertical partitions form the load-bearing structure for the plate sections 72, the first vertical partition 92 is advantageously modified by reducing its height. The first vertical partition 92 can be described in greater detail by referring to FIG. 8, which shows a cross section through the section B-B from FIG. 7. A plurality of passages 94 are made in the first vertical partition 92, in order to allow the aqueous slurry to be distributed on both sides of the first vertical partition 92. The passages 94 also serve to reduce the accumulation of solids in the receiving zone 90.

To reduce the foaming effect, the plate sections 72 in the receiving zone 90 are provided with a reduced number of perforations, thus limiting the evaporation of the monomer with the gas.

The feed pipe (inlet port) 28 enters, as shown in FIG. 7, into the upper chamber 17 and comprises a bend 96 that directs the flow of aqueous slurry into the receiving zone 90. Preferably, the feed pipe (inlet port) 28 is arranged so as to create turbulence of the aqueous slurry in the receiving zone 90.

According to another embodiment, illustrated in FIG. 9, a deflector 98 is provided downstream of the inlet of aqueous slurry into the upper chamber 17. The deflector 98 is designed to break up the flow of the jet of aqueous slurry entering into the upper chamber 17 from the feed pipe (inlet port) 28 and to direct the aqueous slurry into the receiving zone 90. For this purpose, the deflector 98 comprises a part 100 that forms a funnel (cyclone), which part may also comprise means for creating turbulence of the aqueous slurry arriving in the receiving zone 90. It should be noted that the removal or modification of the first vertical partition 92, the turbulence of the aqueous slurry and the deflector 98 are elements which may be used alone or in combination.

1. A stripping column for extracting a component from a liquid medium using a gas, the stripping column comprising:
a vertical column comprising an essentially cylindrical wall, the vertical column being divided by horizontal perforated plates into a series of superposed chambers, each chamber comprising several vertical partitions positioned so as to form chicanes, an upper chamber comprising at least one liquid medium inlet port;
wherein
the upper chamber comprises a liquid medium receiving zone, the receiving zone being configured so as to be able to carry out a degassing of a liquid medium in the receiving zone.

2. The stripping column according to claim 1, wherein the upper chamber has a diameter that corresponds to the diameter of the subjacent chambers.

3. The stripping column according to claim 1, wherein the receiving zone is formed by removing at least one vertical partition.

4. The stripping column according to claim 1, wherein the receiving zone is formed by modifying at least one vertical partition.

5. The stripping column according to claim 4, wherein the vertical partition in the receiving zone has a reduced height relative to the other vertical partitions.

6. The stripping column according to claim 4, wherein the vertical partition in the receiving zone comprises at least one opening in its lower edge.

7. The stripping column according to claim 1, wherein the perforated plate comprises, in the receiving zone, a reduced number of perforations.

8. The stripping column according to claim 1, wherein the stripping column comprises a turbulence means that makes it possible to create turbulence of the liquid medium in the receiving zone.

9. The stripping column according to claim 1, wherein the vertical partitions are attached to the wall of the vertical column and are designed so as to hold the perforated plates.

10. The stripping column according to claim 1, wherein the perforated plates are formed by a plurality of plate sections.

11. The stripping column according to claim 10, wherein the plate sections have a thickness between 2 and 8 mm.

12. The stripping column according to claim 10, the wherein a vertical partition has a cross section in the shape of an upside-down “T”, comprising, on its lower edge, a flange that extends on both sides of the vertical partition and that acts as support for the plate sections.

13. The stripping column according to claim 10, wherein the perforations in the plate sections are essentially cylindrical.

14. The stripping column according to claim 1, wherein a perforated plate comprises a discharge zone with a discharge opening allowing the flow of the liquid medium from one chamber to a subjacent chamber, a barrier being positioned upstream of the discharge opening, the barrier regulating the height of the liquid medium in the chamber.

15. A stripping process for extracting a component from a liquid medium using a gas, comprising using the stripping column according to claim 1.
